(19) United States
(12) Patent Application Publication
(10) Pub. No.: US 2024/0350854 A1
(43) Pub. Date: Oct. 24, 2024

(54) LEVEL BAR

(71) Applicant: TODD FUHRHOP, Coulterville, IL (US)

(72) Inventor: TODD FUHRHOP, Coulterville, IL (US)

(21) Appl. No.: 18/635,651

(22) Filed: Apr. 15, 2024

Related U.S. Application Data
(60) Provisional application No. 63/455,394, filed on Apr. 18, 2023.

(51) Int. Cl. A63B 21/072; A63B 71/06; G01C 9/24

(52) U.S. Cl. CPC A63B 21/0724; A63B 71/06; A63B 2071/0694; G01C 9/24

(57) ABSTRACT

A level barbell is provided for use in connection with resistance training, in which the level barbell promotes the proper, safe use of barbells, dumbbells, and methods of use thereof. The level barbell includes a shaft, the shaft defining an elongated cylindrical bar having opposed first and second ends. The level barbell further includes at least one level assembly, wherein the level assembly is affixed to the level barbell and is configured to communicate one or more orientation of the level barbell with respect to the level barbell's longitudinal axis.

### CROSS-REFERENCE TO RELATED APPLICATIONS

This application claims priority pursuant to 35 U.S.C. 119(e) to co-pending U.S. Provisional Patent Application Ser. No. 63/455,394, filed Apr. 18, 2023, the entire disclosure of which is incorporated herein by reference.

### FIELD OF THE INVENTION

The present invention relates generally to exercise devices. More specifically, the present invention is concerned with devices for resistance training and proper, safe use of barbells, dumbbells, and methods of use thereof.

### BACKGROUND

Beginning with weights made from stones and progressing to the precision engineered weight plates of today, resistance training with weights, barbells, and dumbbells, has remained as one of the most popular techniques of strength training throughout the evolution of the exercise and fitness industry. Weight training is the physical training that often involves lifting weights and is a form of strength training where a user performs an effort against an opposing force, such as gravity acting on the weights, to increase their muscle mass and strength. It is this effort that causes the muscles to contract against the resistance, which results in, not only the increased strength of the muscles themselves, but the development of an athletic physique by increasing the overall muscular appearance of the user's body. Additionally, when properly and safely performed, strength training may improve a user's mental and physical health, build and/or maintain muscle mass, help protect from injury, contribute to an increased life span, burn body fat, increased overall energy, quality of sleep, among many other benefits.

Weight training also exists in many different forms and types of equipment. It is a cornerstone for numerous types of sports, such as bodybuilding, powerlifting, Olympic lifting, and will likely be utilized by people of all ages and body types, for many years to come. Nevertheless, despite its numerous benefits, when not properly or safely executed, lifting weights incorrectly can also result in, or cause, serious injury, disproportionate results, or even death.

Typically, weight training is performed by using weights (or weight plates) in connection with various types of dumbbells or barbells. However, barbells and dumbbells of the prior art suffer from numerous drawbacks. For example, the user's form is a crucial, if not a critical, component of weightlifting and when utilizing improper form serious injury may occur. Unfortunately, barbells and dumbbells of the prior art fail to incorporate devices or methods to reduce the risk of injury due to a user's improper form. Accordingly, it would be beneficial to have a system for and method of reducing risk of injury in connection with weight training, namely when a person uses barbells or dumbbells.

Another drawback of existing systems and methods for weight training in connection with barbells and dumbbells is that barbells and dumbbells of the prior art fail to provide devices or methods to assist a user in developing muscular symmetry (e.g., muscular symmetry such as the user's left and right biceps brachii muscles being equally developed using weight training) while utilizing weighted or resistance training. Accordingly, it would be beneficial to have a system for and method of using barbells or dumbbells to promote muscular symmetry while utilizing weighted or resistance training.

In many scenarios, weight training involves progressively overloading the targeted muscle, or muscles, by performing several repetitions until the muscle achieves failure. Progressive overload is based on increasing the load (e.g., either by increased weight or number of repetitions) which advocates for the gradual increases on the stress placed upon the targeted muscle. However, as more stress is placed on the user's muscle tissue, the risk of injury also increases due to excess fatigue or improper form. Therefore, it's critical for the user to maintain a proper and safe technique and form when lifting weights and progressively increasing muscle stress. Unfortunately, barbells and dumbbells of the prior art fail to incorporate devices or methods to reduce the risk of injury when increasing the stress placed on the targeted muscle during weight training. As such, there exist a need to have a system for and method of using barbells or dumbbells to allow a user to reduce the risk of injury, maintain proper form, and preserve proper technique when lifting weights and progressively increase the intensity to avoid injury.

### SUMMARY

The present invention comprises a level barbell exercise device and methods of use thereof for resistance training and proper, safe use of barbells, dumbbells, and methods of use related to exercise and weight training. For purposes of this disclosure, the terms “barbells” and “dumbbells” shall be interchangeable, each referring to a generally elongated object (including generally straight bars as well as curved shaped bars such as curl bars that allow for a more comfortable and/or natural grip) used for weight/resistance training, stretching, flexibility work, balance exercises, muscle/joint rehabilitation, or the like (collectively, “exercise”).

In various embodiments, the level barbell includes a level assembly, the level assembly being part of a barbell and defining a device and method of use related to exercise and weight training. In one preferred embodiment of the instant invention, the level barbell includes a barbell shaft and at least one level assembly. In some such embodiments the barbell shaft is made of a metal or other suitable material that is intended to support additional weights in addition to the shaft. In other such embodiments the barbell shaft is made of a lighter-weight and/or less durable material, such as a clear plastic material such as acrylic. In some such embodiments, the barbell consists of a plastic rod/tube with a level assembly insert, and is not intended to support any additional weights. In some embodiments of the inventive concept, the lighter-weight barbell is utilized for stretching, flexibility work and balance exercises. In some embodiments the barbell is utilized for muscle/joint rehabilitation.

In other embodiments, of the instant invention, the level barbell includes a barbell shaft, at least two sleeve assemblies, and at least one level assembly. In some embodiments, the barbell shaft includes an elongated cylindrical shaft and, in which, the barbell shaft defines a longitudinal axis. In some embodiments, the sleeve assemblies are affixed to each end of the barbell shaft, a first sleeve assembly being affixed to an opposite and opposed end of the barbell shaft from a second sleeve assembly. In an exemplary embodiment, a sleeve assembly includes a sleeve, a collar, an end cap, a plurality of bearings and/or bushings, a plurality of fasteners, and the sleeve assemblies are configured to for selectively and slidably mounting of weights, weights such as a weight plate or disk.

It will be appreciated that various embodiments of the inventive concept include level barbells of varying weights in embodiments including sleeves for mounting weights and embodiments without sleeves that are not intended to mount any additional weights. Exemplary embodiments of the inventive concept include the following level barbells: 25 pound curl bar with mounting sleeves, 15 pound straight bar with mounting sleeves, 25 pound straight bar with mounting sleeves, 45 pound straight bar with mounting sleeves, and 2 pound acrylic training bar without mounting sleeves. Nevertheless, other embodiments include level bars of various other weights, lengths, and shapes.

In some embodiments of the present invention, the level barbell includes a level assembly being part of the level barbell, wherein the level assembly facilitates and promotes the proper, safe use of barbells, dumbbells, and methods of use related to exercise and weight training. In some embodiments, the level barbell shaft defines a cavity, wherein a level assembly is affixed and located within an interior area of the cavity. In some embodiments, a level assembly is positioned in a central portion of the barbell shaft, the central portion being defined by a midpoint of the barbell shaft with equally weighted barbell shaft portions extending in opposite directions from the midpoint. In some embodiments, the level assembly is placed in a middle portion of the level barbell. In other embodiments, the level barbell includes a plurality of level assemblies, the plurality of level assemblies being placed in a plurality of locations in the level barbell. In an exemplary embodiment of the instant invention, a level assembly is viewable and, in a line of site, of a user while utilizing the level barbell during an exercise, such as weight training, thereby facilitating and promoting the proper, safe use of barbells, dumbbells, and methods of use related to exercise and weight training.

One object of the instant invention is to provide a level barbell exercise device and methods of use thereof for resistance training and proper, safe use of barbells, dumbbells, and methods of use related to exercise and weight training. Another object of the instant invention is to provide a system, apparatus, and methods for reducing risk of injury in connection with weight training, namely when a person uses barbells or dumbbells in connection with an exercise. It is another object of the instant invention is to provide a system, apparatus, and methods for using barbells or dumbbells to promote muscular symmetry while utilizing weighted or resistance training. Yet another object of the present invention is to provide a system, apparatus, and methods for using barbells or dumbbells that enable a user to reduce the risk of injury, maintain proper form, and preserve proper technique when lifting weights and progressively increase the intensity to avoid injury.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

Embodiments of the present invention are described in detail below with reference to the attached drawing figures, wherein:

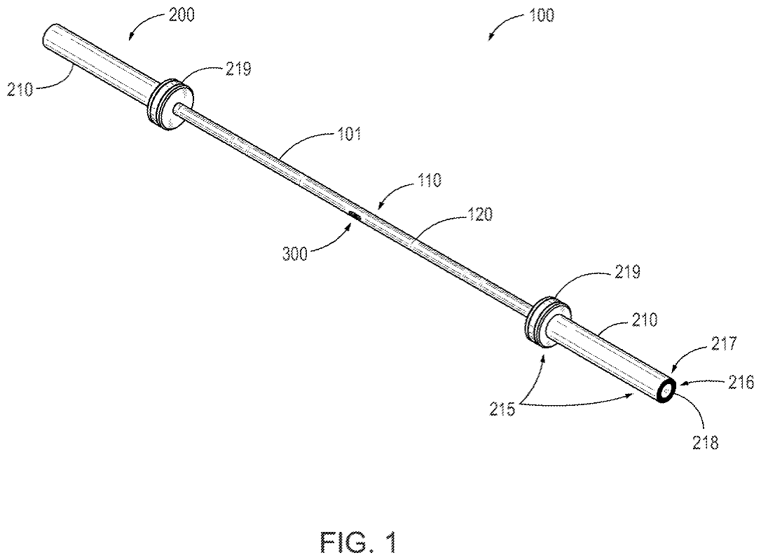

FIG. 1 is a perspective view of one embodiment of a level barbell according to the present invention.

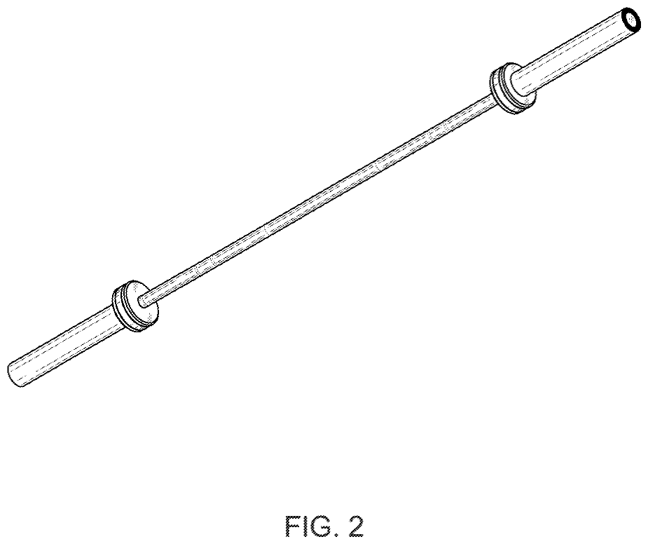

FIG. 2 is a perspective view of one embodiment of a level barbell according to the present invention.

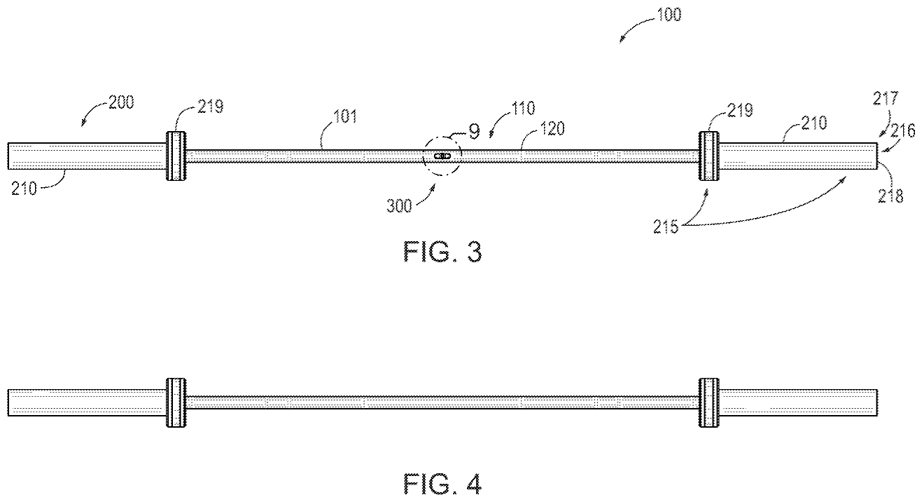

FIG. 3 is a plan view of one embodiment of a level barbell according to the present invention.

FIG. 4 is a plan view of one embodiment of a level barbell according to the present invention.

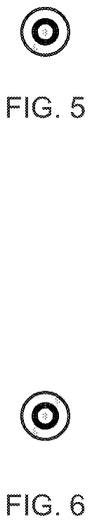

FIG. 5 is a plan view of one embodiment of a level barbell according to the present invention.

FIG. 6 is a plan view of one embodiment of a level barbell according to the present invention.

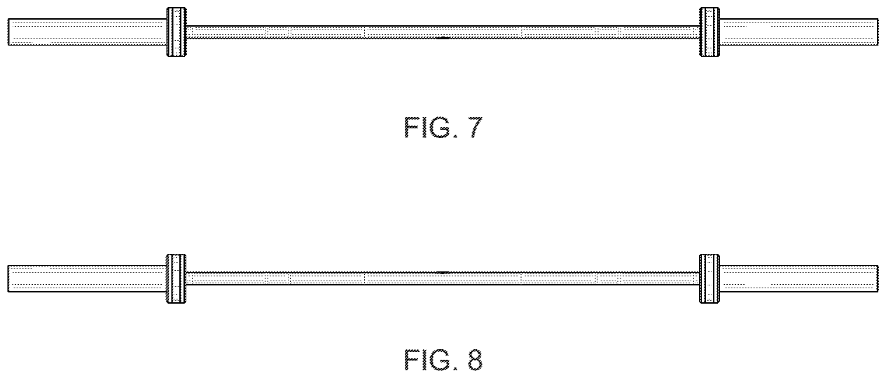

FIG. 7 is a plan view of one embodiment of a level barbell according to the present invention.

FIG. 8 is a plan view of one embodiment of a level barbell according to the present invention.

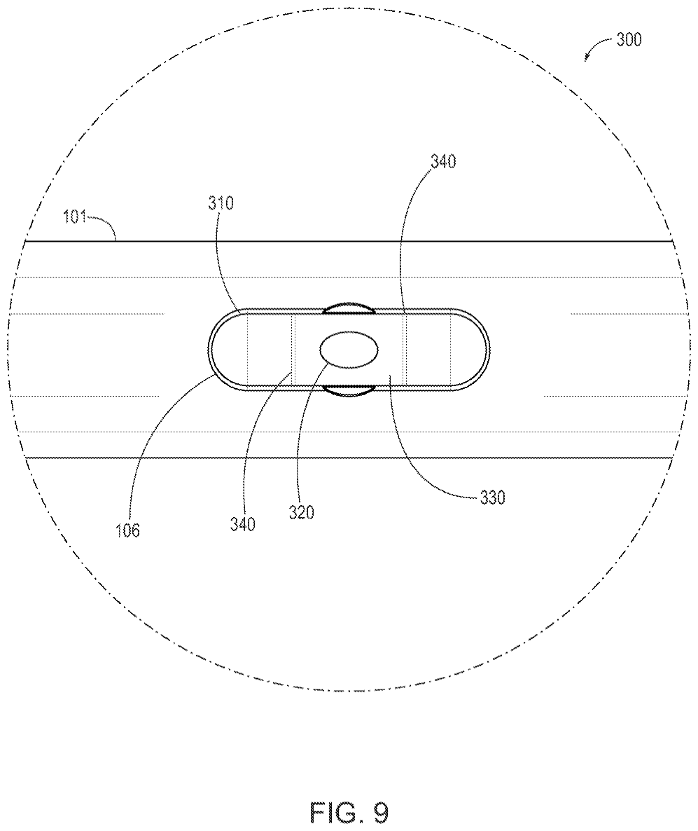

FIG. 9 is a plan view of one embodiment of a level barbell according to the present invention.

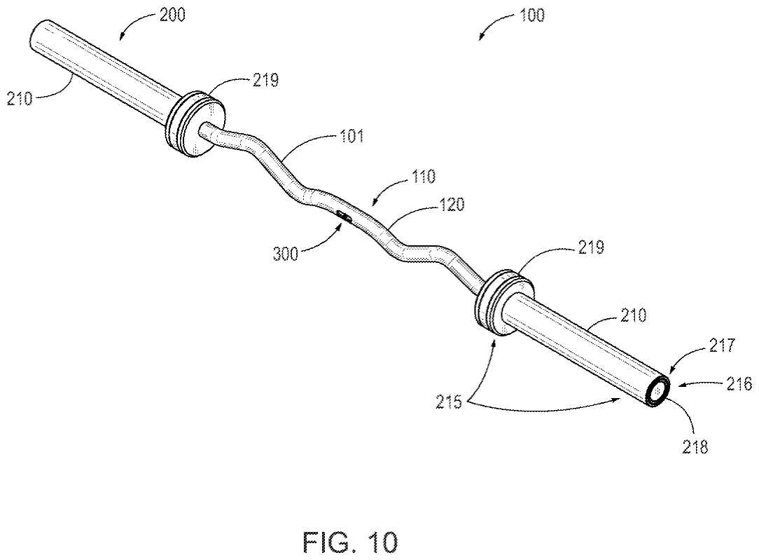

FIG. 10 is a perspective view of one embodiment of a level barbell according to the present invention.

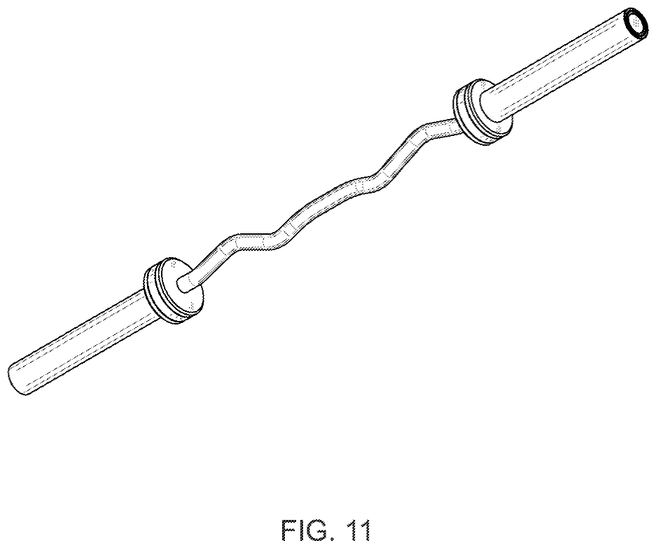

FIG. 11 is a perspective view of one embodiment of a level barbell according to the present invention.

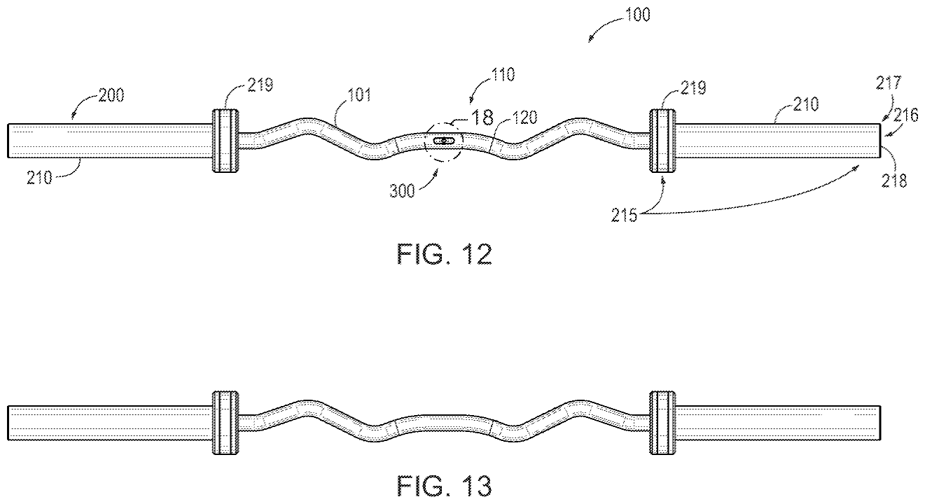

FIG. 12 is a plan view of one embodiment of a level barbell according to the present invention.

FIG. 13 is a plan view of one embodiment of a level barbell according to the present invention.

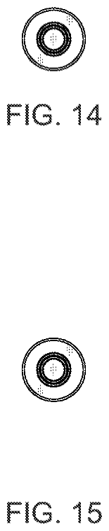

FIG. 14 is a plan view of one embodiment of a level barbell according to the present invention.

FIG. 15 is a plan view of one embodiment of a level barbell according to the present invention.

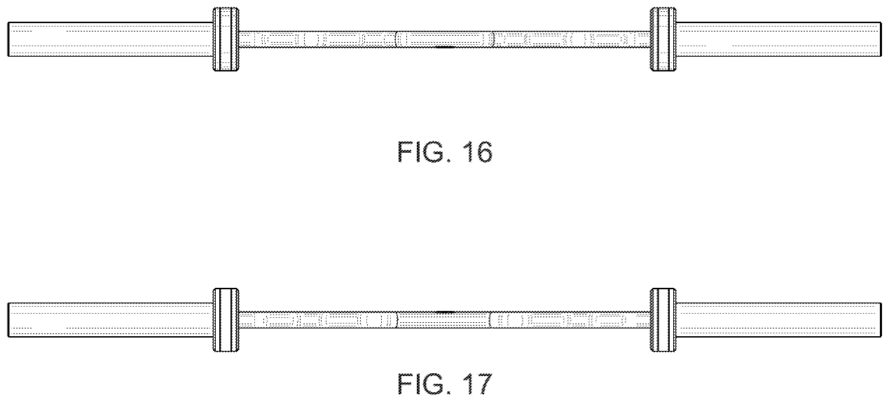

FIG. 16 is a plan view of one embodiment of a level barbell according to the present invention.

FIG. 17 is a plan view of one embodiment of a level barbell according to the present invention.

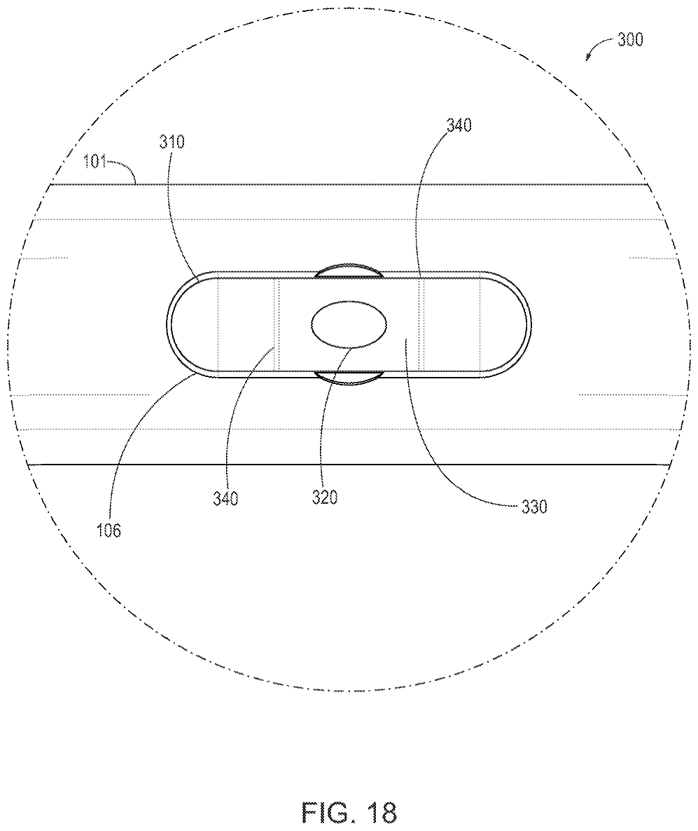

FIG. 18 is a plan view of one embodiment of a level barbell according to the present invention.

The drawing figures do not limit the present invention to the specific embodiments disclosed and described herein. The drawings are not necessarily to scale, emphasis instead being placed upon illustrating the principles of the invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to FIG. 1, the present invention discloses a level barbell 100 and method of use for safely and properly engaging in an exercise, such as weight training. In one preferred embodiment of the present invention, the level barbell 100 includes a shaft 101 and two sleeve assemblies 200. In some embodiments, the level barbell 100 shaft 101 is defined by an elongated cylindrical member and, in which the barbell shaft 101 defines a longitudinal axis. With further reference to FIG. 1 and in some embodiments, the level barbell 100 includes two sleeve assemblies 200, each sleeve assembly 200 being affixed to opposite end portions of the shaft 101. In one preferred embodiment of the present invention, a level barbell 100 is configured in such a way that a user is able to removably and slidably attach weight plates, of varying weights, to the sleeve assemblies 200.

Generally referring to FIGS. 1 through 8, one embodiment of a level barbell 100 is shown, in which the level barbell 100 incudes a shaft 101. In some embodiments, the shaft 101 defines an elongated cylindrical body and is made from steel, aluminum, a spring-metal, such as spring-steel, or similar material. In some embodiments, the shaft 101 defines a length of the level barbell 100, with respect to the longitudinal axis of the level barbell 100 and is configured to be utilized in a variety of different exercises. In one preferred embodiment of the instant invention, the shaft 101 is configured such that it provides a user a gripping area while using the barbell 100 during an exercise. In some embodiments, the level barbell 100 shaft 101 is defined by an outer diameter, for example an overall outer diameter of 25 millimeters to 50 millimeters. In other embodiments, the shaft 101 is defined by an overall length along its longitudinal axis, such as an overall length ranging from 1.2 meters to 2.4 meters. In some embodiments of the present invention, the shaft 101 includes an engraved pattern, such as a knurled crosshatch pattern 110. In another embodiments, the shaft 101 includes one or more knurl marks 120. In other embodiments, knurl marks 120 are areas of the shaft 101 that do not include a knurled crosshatch pattern 110 and are placed in a plurality of locations along the shaft 101. In some embodiments, the knurl marks 120 are configured to assist a user to grip the level barbell 100 shaft 101.

Referring to FIGS. 1 through 8, the level barbell 100 includes a pair of sleeve assemblies 200. As shown in FIG. 1, a first sleeve assembly 200 is affixed to a first end of the shaft 101 and a second sleeve assembly 200 is affixed to a second end of the shaft 101, the second end being opposite from the first end. It will be appreciated that in some embodiments, the sleeve assembly 200 is rotatably affixed to the shaft 101. In other embodiments, the sleeve assembly 200 is formed as an integral part of the level barbell 100. In some embodiments, when a sleeve assembly 200 is affixed to an end portion of the level bar 100 (e.g., the outermost end of the level barbell 100), the sleeve assembly 200 provides a structure where weights, such as weight plates, are capable of being slidably mounted to the level barbell 100. In some embodiments, a sleeve assembly includes a sleeve 210, a collar 219, an end cap 218, a plurality of bearings and/or bushings 215, a plurality of fasteners 217, and a plurality of washers 216, such as spacer washers. In some embodiments, the sleeve assemblies are comprised of the same material as the level barbell 100, such as metal, steel, aluminum, or the like. In other embodiments, the sleeve assemblies 200 are made from materials different that the level barbell 100. It will be appreciated, that in some embodiments the sleeve assembly 200 include a smooth surface, which provides for ease of use when loading or offloading weight plates onto or from the level barbell 100.

Referring to FIGS. 1 through 8 and in one preferred embodiment, a sleeve assembly 200 includes a sleeve 210. In some embodiments of the present invention, a sleeve 210 includes an elongated cylindrical member having an overall length extending in a direction that is parallel with the longitudinal axis of the level barbell 100. In some embodiments, the sleeve 210 includes a void, such as a bore, thereby defining an inner area of the sleeve 210. In some such embodiments, the sleeve 210 includes an overall outer diameter and an inner diameter. In some such embodiments, the sleeve 210 includes an outer surface and an inner surface. It will be appreciated that in some embodiments, a sleeve 210 includes a first end extending from an end position of the shaft 100 in a direction along the longitudinal axis of the level barbell 100 towards a sleeve second end, the sleeve second end being affixed to a collar 219. In some embodiments, a sleeve 210 is slidably engaged with the level barbell 100 shaft and is affixed such that the sleeve 210 is freely rotatable about the longitudinal axis of the shaft 101, to the shaft 101 by a fastener, such as one or more snap ring 217. It will be appreciated that in some embodiments, one or more bushings or bearings 215 is affixed to an outer surface of the shaft 101 and is in contact with an inner surface of a sleeve 210, thereby enabling the sleeve assembly 200 to be a freely rotatable and affixed to the level barbell 100. In some embodiments the sleeve 210 outsider outer diameter includes a range from 25 mm to 30 mm. Yet in other embodiments, the sleeve 210 outside outer diameter includes other ranges over or below an overall outside diameter of 25 mm to 30 mm.

As shown in FIGS. 1 through 8, in some embodiments of the instant invention a sleeve assembly 200 includes a collar 219. In some embodiments, the sleeve assembly 200 includes a sleeve 210 that extends from an outer portion of the shaft 101 in a direction towards a collar 219, the collar 219 being position being positioned towards a central portion of the shaft 101 and distal from the outer portion of the shaft 101. In some embodiments, the collar 219 is displaced along the level bar longitudinal axis from the outer portion of the level barbell 100 and is positioned in a direction towards a middle portion of the level barbell 100. It will be appreciated that a collar 219 provides a stop, such that the collar 219 prevents weight plates from moving past the sleeve assembly 200 and towards the middle portion of the shaft 101. In some embodiments the collar 219 defines an overall outside diameter. In other embodiments, the collar 219 defines an overall outside diameter that is larger than the sleeve 210 overall outside diameter.

In some embodiments, the collar 219 includes a void, such as a bore, thereby defining an inner area of the collar 219. In some such embodiments, the collar 219 includes an overall outer diameter and an inner diameter. In some such embodiments, the collar 219 includes an outer surface and an inner surface. It will be appreciated that in some embodiments, a collar 219 includes a first end extending from an end portion of the sleeve 210 in a direction substantially parallel with the longitudinal axis of the level barbell 100 towards a collar 219 second end. In some embodiments, a collar 219 is slidably engaged with the level barbell 100 shaft and is affixed and freely rotatable around the longitudinal axis (i.e., generally about an orthogonal axis of the level bar) of the shaft 101, to the shaft 101 by a fastener, such as one or more snap ring 217 or bushing 215.

In some embodiments of the instant invention, the level barbell 100 includes a plurality of bushings or bearings 215, which facilitate the rotational movement of the sleeve assembly 200 around the longitudinal axis of the shaft 101. It will be appreciated that various types of weightlifting exercises benefit from different types of sleeve assembly 200 rotation, or “spin.” For example, in regard to a slower type of lifting exercise, such as a deadlift, the user typically benefits from a slower spin. Contrasted with type of lift that involves a much faster movement on behalf of the lifter, such as a clean and jerk, the user will usually benefit from a faster spin. Referring to FIGS. 1 through 8, in some embodiments, the level barbell 100 includes a plurality of bushings 215. In some embodiments, the bushings 215 are affixed and freely rotatable to an end portion of the shaft 101. In some such embodiments, an inner surface of the bushing is engaged with an outer surface of the shaft 101 and an outer surface of the bushing is engaged with a sleeve 210 inner surface, thereby facilitating rotational movement of the sleeve assembly 200 independent of the shaft 101. In other embodiments, an inner surface of the bushing is engaged with an outer surface of the shaft 101 and an outer surface of the bushing is engaged with a collar 219 inner surface, thereby facilitating rotational movement of the sleeve assembly 200 independent of the shaft 101.

Still referring to FIGS. 1 through 8, in some embodiments, the level barbell 100 includes a plurality of bearings 215. In some embodiments, the bearings 215 are affixed and freely rotatable to an end portion of the shaft 101. In some such embodiments, an inner surface of the bearings is engaged with an outer surface of the shaft 101 and an outer surface of the bearings is engaged with a sleeve 210 inner surface, thereby facilitating rotational movement of the sleeve assembly 200 independent of the shaft 101. In other embodiments, an inner surface of the bearings is engaged with an outer surface of the shaft 101 and an outer surface of the bearings is engaged with a collar 219 inner surface, thereby facilitating rotational movement of the sleeve assembly 200 independent of the shaft 101. Yet in other embodiments, it will be appreciated that a level barbell 100 includes both a plurality of bearings and a plurality of bushings.

In one preferred embodiment of the level barbell 100, the level barbell 100 includes one or more end cap 218. It will be appreciated that in some embodiments, the end cap 218 includes information or designs specified to the level barbell 100 or the respective manufacture. In FIG. 1 and in some embodiments, the end cap 218 is affixed to the level barbell by a fastener such as a snap ring or a screw. In other embodiments, a end cap 218 is affixed to a level barbell 100 by means of a threaded connection.

In an exemplary embodiment of the instant invention, a level barbell 100 includes a level assembly 300. In some embodiments of the present device, a level barbell 100 includes a plurality of level assemblies 300. With reference to FIG. 9, a level assembly 300 according to one embodiment of the instant invention is shown. As demonstrated in FIG. 9, a level barbell 100 shaft 101 defines a cavity 106. In some such embodiments, the cavity 106 is a milled cutaway portion the shaft 101, thereby the cavity defines an interior area or void in the shaft 101. In other embodiments, a cavity 106 is defined by an aperture extending from a first surface of the shaft 101 to a second surface of the shaft 101, such that the cavity 106 passes all the way though the shaft 101 with respect to an axis being perpendicular to a longitudinal axis of the level barbell 100. In some embodiments, the cavity 106 interior void area includes a length (the length dimension being parallel with respect to the level barbell 100 longitudinal axis) of approximately 1¾ inches, a depth of 7/16 inches, and a height of 7/16 inches.

Still with reference to FIG. 9, in some embodiments of the present invention, a level assembly 300 is mounted within an interior area and affixed to an interior area surface of the cavity 106. In some embodiments, a user is enabled to view a level assembly 300 a first side of the shaft 101. In other embodiments, a user is able to view a level assembly 300 from a plurality of sides of the shaft 101. In some embodiments, a user is enabled to view a level assembly 300 from a front portion of a level barbell 100 shaft 101 surface and a back portion of the level barbell 100 shaft 101 surface. As shown in FIG. 9 and in some embodiments, a level assembly 300 includes a transparent tube 310, the transparent tube 310 being filled with a fluid 330 and including an air pocket or bubble 320, for example such as a bubble level. While other materials are contemplated, in some embodiments a transparent tube 310 is made from a plastic, acrylic, glass, or the like. In some embodiments, the overall length of the tube 310 is 1½ inches and is defined by an outer diameter of 5/16 inches. In other embodiments, a level assembly tube 340 includes one or more guidelines 340.

With reference to FIGS. 1 through 12, it will be appreciated that a level assembly 300 is placed in a middle portion of the level barbell 100. While FIG. 9 portrays a level assembly 300 in a horizontal position (the longitudinal axis of the transparent tube 310 longitudinal axis being substantially parallel to the level barbell 100 longitudinal axis), it will be appreciated that other level assembly 300 orientations are contemplated by the instant invention. In some embodiments, a level barbell 100 middle portion is placed between a level barbell 100 first section and a level barbell 100 second section, wherein the level barbell 100 first section is equal in weight to the level barbell 100 second section. In other embodiments, a level barbell 100 middle portion is placed between a level barbell 100 first section and a level barbell 100 second section, wherein the level barbell 100 first section is not equal in weight to the level barbell 100 second section. In some embodiments of the instant invention, a level assembly 300 is affixed to a level barbell 100 cavity 106 by an adhesive. In other embodiments, a level assembly 300 is affixed to a level barbell 100 cavity 106 by a fastener, such as a screw.

In some embodiments, a level assembly 300 is a bubble type leveling assembly. In other embodiments, a level assembly includes light emitting diodes (“LED”) and uses the LEDs as indicators to denote the level bar assembly's positioning. Yet in other embodiments, other types of level assembly 300 devices are contemplated.

With reference to FIGS. 10 through 18, another embodiment of the level barbell 100 device is shown. With regards to FIG. 10 though 18 and in some such embodiments, the level barbell includes a curl barbell configuration, such as an EZ curl barbell; however, it will be appreciated that in other embodiments the level barbell device includes differing types or configuration of barbells, such as an Olympic bar, dumbbell, power barbell, deadlift barbell, squat barbell, trap barbell, multi-grip barbell, safety squat barbell, cambered barbell, log barbell, straight elongated cylindrical training bar, or the like.

In an exemplary embodiment of the present invention, after user (i.e., a lifter/exercise) slidably mounts one or more weights (in embodiments in which weights are mounted to the level barbell), such as a weight plate or disk, to the sleeve assembly 200, the shaft 101 of the level barbell 100 becomes the primary load carrying member of the level barbell 100 and provides the lifter a gripping surface, such that the user is able to exert an effort against an opposing force, such as gravity acting on the weights, while moving the level barbell 100 from a first position to a second position. In some embodiments, a level assembly 300 is visible to a lifter while utilizing the level barbell 100 during an exercise. In some such embodiments, a lifter is able to view a level assembly 300 while moving the level barbell 100 from a first position to a second position.

In one embodiment of the instant invention, the level barbell 100 is in its level configuration when the level assembly's bubble 320 is positioned between a first and second guidelines 340 of the level assembly 300. In some embodiments, the level barbell 100 is in its level configuration when the longitudinal axis of the level barbell 100 is substantially parallel with a surface, such as the ground. Yet in other embodiments, the level barbell is not in its level configuration when the level assembly's bubble 320 is positioned out said a first or second guidelines 340 of the level assembly 300.

In one preferred embodiment, before exerting an effort against an opposing force, the lifter views the level assembly 300 and adjust the level barbell 100 such that the bubble 320 within the level assembly tube 310 is positioned between a first and second guidelines 340. By placing the level assembly 300 bubble 320 between a first and second guidelines 340, the user is able to adjust their body positioning or the level barbell 100 to ensure the level barbell 100 is in a balanced position before beginning their exercise. As the lifter moves the level barbell 100 from its first position towards a second position, the user is able to view the level assembly 300 and ensure they keep the bubble 320 between a first and second guidelines 340 while moving the level bar 101 towards a second position. It will be appreciated that, as the lifter focuses on maintaining the level assembly 300 in its respective level configuration (that is, keeping the bubble 320 between a first and second guidelines 340), the level barbell 100 helps the user in lifting the level barbell (and any mounted weights, if applicable) in a controlled manner, urges the lifter to maintain proper form and technique, reduces risk of injury, results in increased safety while exercising, and promotes muscular symmetry.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A level barbell comprising:
a shaft, the shaft being an elongated cylindrical member having:
a longitudinal axis defining its length, and
a first end spaced apart and opposed to a second end,
wherein the shaft further includes a middle portion, the middle portion being positioned between the first and second ends, and
wherein the middle portion defines a cavity, the cavity being positioned at a central point in the middle portion.

2. The level barbell as claimed in claim 1, further comprising:
a first sleeve assembly, the first sleeve assembly being affixed to the first end of the shaft; and
a level assembly, and wherein the level assembly is positioned within an interior area defined by the cavity.

3. The level barbell as claimed in claim 2, the first sleeve assembly being affixed to the shaft first end such that the first sleeve assembly is freely rotatable around the shaft.

4. The level barbell as claimed in claim 2, further comprising a second sleeve assembly, wherein the second sleeve assembly is affixed to the second end of the shaft.

5. The level barbell as claimed in claim 4, wherein the second sleeve assembly being affixed to the shaft second end such that the second sleeve assembly is freely rotatable around the shaft.

6. The level barbell as claimed in claim 1, wherein the cavity is positioned in a first surface of the middle portion, wherein the cavity extends away from the first surface towards an opposing middle portion surface, and wherein the cavity extends in a direction that is substantially perpendicular to the shaft's longitudinal axis.

7. The level barbell as claimed in claim 6, wherein the void area extends from first surface to an inner portion of the shaft.

8. The level barbell as claimed in claim 1, the leveling assembly further comprising:
a vial; and
one or more guidelines, the guidelines being located on an outer surface of the vial, and wherein the guidelines extend around the circumference of the outer surface area in a direction that is substantially perpendicular to the shaft's longitudinal axis.

9. The level barbell as claimed in claim 8, the vial being formed from an optically transparent material, such that a user is able to view a bubble within an amount of fluid contained in the vial.

10. The level barbell as claimed in claim 1, wherein the level assembly is viewable by a user performing an exercise from a first surface of the shaft middle portion.

11. The level barbell as claimed in claim 10, wherein the exercise is weight training such that the user performs an effort against an opposing force, such as gravity acting on one or more weights.

12. A method of exercise, the method comprising:
positioning a user near a middle portion of a level barbell such that the user is presented with gripping area in the middle portion of the level barbell;
gripping the middle portion of the level barbell by the user;
viewing a level assembly by the user, the level assembly being located at a center point along a level barbell's shaft, wherein the user employs the level assembly to adjust one or more orientation of the level barbell;
positioning the level barbell in a level orientation;
exerting an effort against an opposing force by the user, such as gravity acting on the level barbell,
moving the level bar from a first position to a second position, while maintaining the level orientation.

13. The method of claim 12, further comprising the step of mounting one or more weight plates to a sleeve assembly of the level barbell.

14. The method of claim 12, wherein the level barbell comprises:
a shaft, the shaft being an elongated cylindrical member having:
a longitudinal axis defining its length, and
a first end spaced apart and opposed to a second end,
wherein the shaft further includes a middle portion, the middle portion being positioned between the first and second ends, and
wherein the middle portion defines a cavity, the cavity being positioned at a central point in the middle portion.

15. The method of claim 14, wherein the level assembly, and wherein the level assembly is positioned within an interior area defined by the cavity.

16. The method of claim 15, wherein the leveling assembly comprises:
a vial; and
one or more guidelines, the guidelines being located on an outer surface of the vial, and wherein the guidelines extend around the circumference of the outer surface area in a direction that is substantially perpendicular to the shaft's longitudinal axis.

17. The method of claim 16, the vial being formed from an optically transparent material, such that the user is able to view a bubble within an amount of fluid contained in the vial.

18. The method of claim 16, wherein the level assembly is viewable by a user performing an exercise from a first surface of the shaft middle portion.

19. The method of claim 18, wherein the level orientation is defined by the level barbell's longitudinal axis being substantially parallel with a surface, and wherein the surface is the ground.

20. The method of claim 19, wherein positioning the level barbell in a level orientation comprises:
making adjustments to level barbell with respect to the one or more orientation;
causing a bubble to move to in a position between a first and second guidelines, wherein when the bubble is substantially positioned between a first and second guidelines, the level barbell is in its level orientation.
